(19) United States
(12) Patent Application Publication
(10) Pub. No.: US 2008/0194292 A1
(43) Pub. Date: Aug. 14, 2008

(54) Portable communication device

(75) Inventors: Hiromichi Naito, Okazaki-city (JP); Nobuya Watabe, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/078,368

(22) Filed: Mar. 31, 2008

Related U.S. Application Data
(62) Division of application No. 11/270,451, filed on Nov. 10, 2005.

(30) Foreign Application Priority Data
Nov. 15, 2004 (JP) 2004-330150

(51) Int. Cl. H04M 1/00; B60R 25/00

(52) U.S. Cl. 455/556.1; 340/5.72

(57) ABSTRACT

A communication module is mounted in a user-carried portable telephone, so that the portable telephone and the communication module cooperate. When a user performs a vehicle wheel physical state request operation, a wheel physical state request signal is transmitted to a wheel physical state transmitter, so that wheel physical state data is received from the wheel physical state transmitter and displayed on a display device. Further, on receiving a probe signal from a smart entry vehicle unit, a lock/unlock signal is transmitted for automatically unlocking doors of the vehicle. When a user performs a lock/unlock operation, an unlock signal is transmitted for locking or unlocking doors of the vehicle.

### CROSS REFERENCE TO RELATED APPLICATION

This application is based on and incorporates herein by reference Japanese Patent Application No. 2004-330150 filed on Nov. 15, 2004.

### FIELD OF THE INVENTION

The present invention relates to a portable communication device mounted in a vehicle for wirelessly transmitting a lock/unlock signal to a door device that unlocks vehicle doors when wirelessly receiving the lock/unlock signal.

### BACKGROUND OF THE INVENTION

Conventionally, a keyless entry system and a smart entry system have been widely used. In those systems, a door locking device of a vehicle receives a signal transmitted from a user-carried wireless communication device, thereby unlocking vehicle doors.

Furthermore, conventionally, a communication device mounted in a wheel transmits physical states of the wheel such as tire air pressure and tire temperature of the wheel as a radio signal.

### SUMMARY OF THE INVENTION

The present invention has its first object to provide a user-carried communication equipment that has a function to transmit a lock/unlock signal for locking and unlocking vehicle doors, and a function to receive and display physical states of wheels as a radio signal.

Since many users recently carries portable electronic equipment such as PDA and cellular phone, it will be demanded to add a function for transmitting a lock/unlock signal to such portable electronic equipment. However, since the life cycle of vehicles is different from that of portable electronic equipment, it has been difficult to incorporate a function for transmitting a lock/unlock signal into the portable electronic equipment.

The present invention has its second object is to provide a communication device having a lock/unlock signal transmission function that is detachably mounted in a portable electronic equipment.

According to the present invention, a user-carried portable communication device has a display device, a receiving circuit, a transmitting circuit and a control circuit. The control circuit instructs the transmitting circuit to transmit a lock/unlock signal to a door locking device, and instructs the display device to display the physical state of a wheel when the receiving circuit wirelessly receives a detection signal indicative of the wheel physical state.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram of a communication system according to a first embodiment of the present invention;

FIG. 2 is a block diagram of a hardware configuration of wheel physical state transmitters in the first embodiment;

FIG. 3 is a block diagram of a hardware configuration of a smart entry vehicle unit in the first embodiment;

FIG. 4 is a drawing schematically showing the appearance of a portable telephone and a communication module in the first embodiment;

FIG. 5 is a block diagram of a hardware configuration of a portable telephone in the first embodiment;

FIG. 6 is a block diagram showing a hardware configuration of a communication module in the first embodiment;

FIG. 7 is a flowchart of a program executed by a module control circuit in the first embodiment;

FIG. 8 is a flowchart of a program executed by a telephone control circuit in the first embodiment;

FIG. 9 is a flowchart of a program executed by a module control circuit in the first embodiment;

FIG. 10 is a flowchart of a portable communication device in a second embodiment of the present invention; and

FIG. 11 is a flowchart of a program executed by a control circuit in the second embodiment.

### DETAILED DESCRIPTION OF THE EMBODIMENTS

### First Embodiment

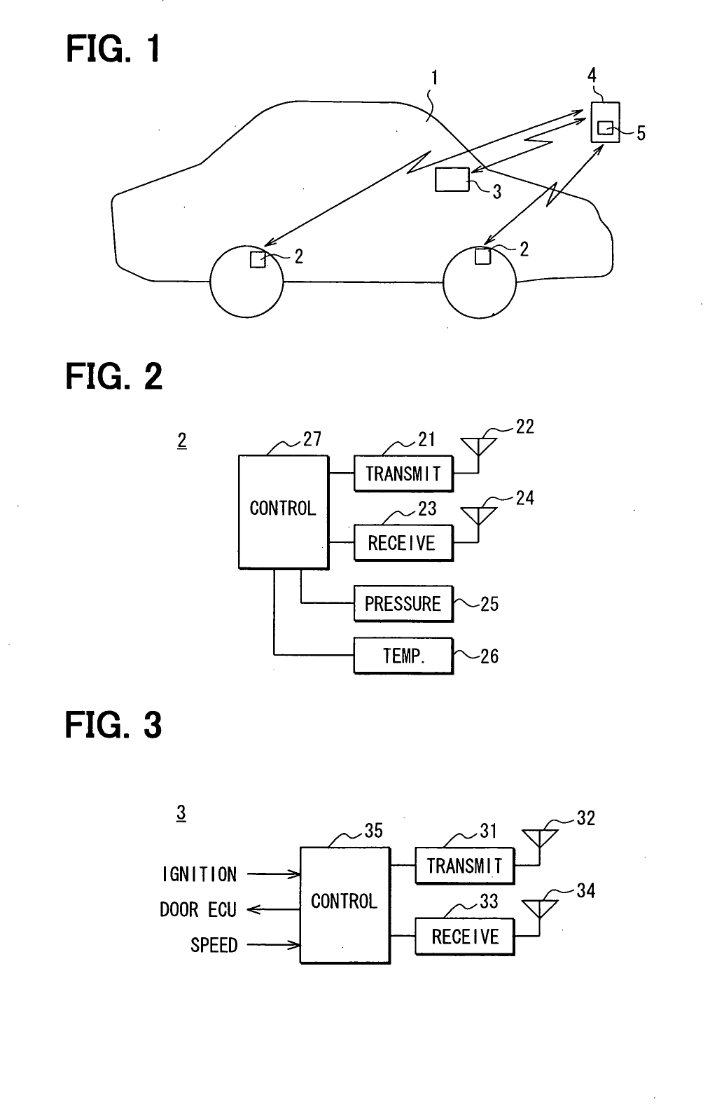

Referring first to FIG. 1, a communication system includes a wheel physical state transmitter 2 mounted one on each wheel 1a of a vehicle 1, a smart entry vehicle unit 3 mounted on the body of the vehicle 1, a portable telephone 4 for performing wireless telephone communications over PHS, PDC, CDMA and the like, and a communication module 5 of card type. The portable telephone 4 includes a card slot, and the communication module 5 is housed in the card slot so that it is detachably mounted in the portable telephone 4. With the communication module 5 mounted in the portable telephone 4, when power is supplied from the portable telephone 4 to the communication module 5, the communication module 5 becomes operable to communicate with the wheel physical state transmitter 2 and the smart entry vehicle unit 3.

As shown in FIG. 2, the wheel physical state transmitter 2 includes a transmitting unit 21, a transmitting antenna 22, a receiving unit 23, a receiving antenna 24, a pressure sensor 25, a temperature sensor 26 and a control unit 27. In the wheel physical state transmitter 2, on receiving a signal to request the transmission of physical state of the wheel (thereinafter referred to as a tire state request signal), the receiving unit 23 performs processing such as amplification, frequency conversion, demodulation and analog-to-digital conversion for the signal to turn the signal into data recognizable by the control unit 27, and then outputs the data to the control unit 27.

On receiving the data based on the tire state request signal, the control unit 27, from the pressure sensor 25 for detecting a tire air pressure and the temperature sensor 26 for detecting a tire temperature, acquires tire air pressure data and tire temperature data, respectively, and outputs the acquired data as well as the identification code of the vehicle to the transmitting unit 21. The transmitting unit 21 performs processing such as digital-to-analog conversion, modulation, amplification, and frequency conversion for the data received from the control unit 27, and wirelessly transmits a signal indicating the result through the transmitting antenna 22.

Thus, on wirelessly receiving a signal to request the transmission of physical state of the mounted wheel (tire air pressure and tire temperature), the wheel physical state transmitter 2 wirelessly transmits a signal indicating the physical state of a wheel concerned.

As shown in FIG. 3, the smart entry vehicle unit 3 includes a transmitting unit 31, a transmitting antenna 32, a receiving unit 33, a receiving antenna 34 and a control unit 35. In the smart entry vehicle unit 3, the control unit 35 periodically (e.g., an interval of one second) acquires an ignition signal of the vehicle 1 and a vehicle speed signal from a vehicle speed sensor, and based on the acquired signals, outputs an ignition position (ON, OFF, ACC, etc.) of the vehicle 1, a vehicle speed of the vehicle 1, and vehicle data including identification code of the smart entry vehicle unit 3 to the transmitting unit 31. The transmitting unit 31 performs processing such as digital-to-analog conversion, modulation, amplification, and frequency conversion for the vehicle data received from the control unit 35, and wirelessly transmits a signal indicating the result (hereinafter referred to as a probe signal) through the transmitting antenna 32. Thus, the smart entry vehicle unit 3 periodically wirelessly transmits the probe signal into the surrounding area. Since a reach range of the probe signal is within about 1 m radius of the smart entry vehicle unit 3, the antenna 32 of the smart entry vehicle unit 3 is often placed in the vicinity of the doorknobs of the vehicle.

In the smart entry vehicle unit 3, on newly receiving a lock/unlock signal including verification code from the receiving antenna 34, the receiving unit 33 performs processing such as amplification, frequency conversion, demodulation, and analog-to-digital conversion for the signal to turn the signal into data recognizable by the control unit 35, and then outputs the data to the control unit 35. On receiving the data based on the lock/unlock signal, the control unit 35 determines whether the verification code included in the lock/unlock signal matches predetermined code specific to the smart entry vehicle unit 3. If so, it outputs a signal to request to lock or unlock the doors to a door ECU that controls the locking or unlocking of the doors of the vehicle. On receiving the signal, the door ECU locks or unlocks the doors of the vehicle 1. Thus, the smart entry vehicle unit 3 locks or unlocks of the doors of the vehicle according to the predetermined lock/unlock signal wirelessly received.

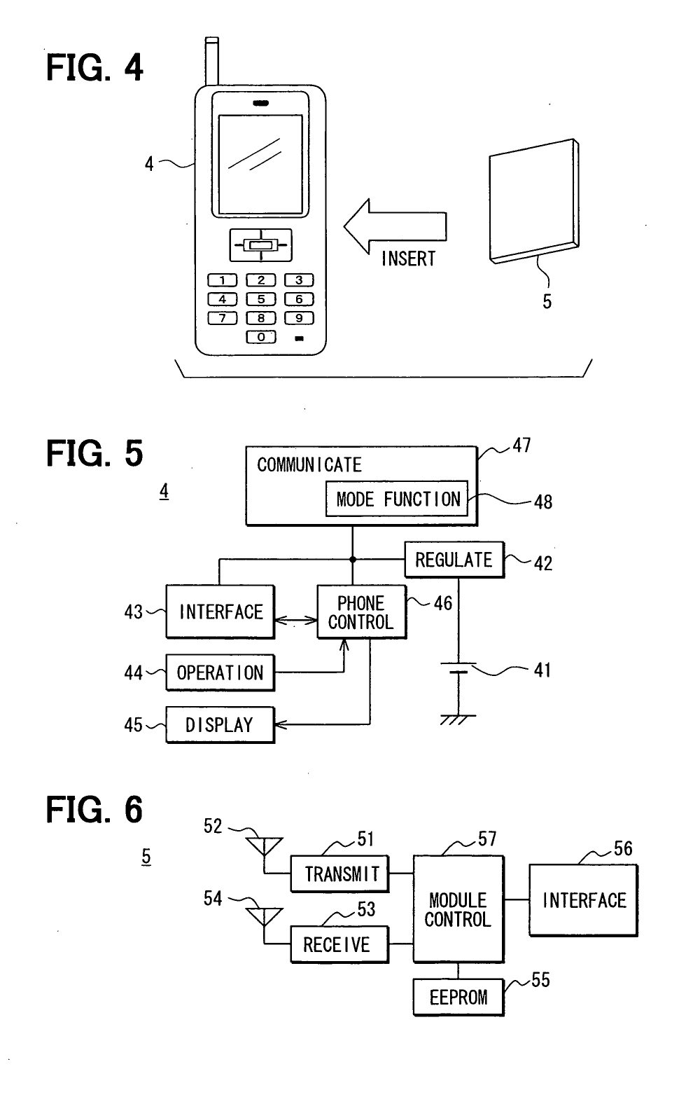

As shown in FIG. 4 the portable telephone 4 is constructed for communicating with each wheel physical state transmitter 2, the smart entry vehicle unit 3 and the communication module 5. The portable telephone 4 includes a mounting slot (not shown) for mounting compact flash (registered trademark), Smart Media, and the like. The communication module 5 is card-shaped so that it can be wholly or partially inserted in the slot.

As shown in FIG. 5, the portable telephone 4 includes a battery 41, a voltage regulator circuit 42, an interface circuit 43, an operation device 44, a display device 45, a telephone control circuit 46 and a wireless communication unit 47.

The voltage regulator circuit 42 regulates a voltage applied from the battery 41 to a constant voltage and supplies power to the components of the portable telephone 4. The power supply enables the components of the portable telephone 4 to operate.

The interface circuit 43 is disposed in an inner portion of the mounting slot and shaped so that the communication module 5 can be detachably mounted. Via the interface circuit 43, power from the voltage regulator circuit 42 and a signal from the telephone control circuit 46 are outputted to the mounted devices, and a signal from the mounted devices is outputted to the telephone control circuit 46.

The operation device 44 accepts a user operation by buttons, switches, and the like, and outputs a signal corresponding to the accepted operation to the telephone control circuit 46.

The display device 45 includes an image display device such as a liquid crystal display that outputs a video based on a video signal received from the telephone control circuit 46, and a loudspeaker that outputs a sound based on a tone signal received from the telephone control circuit 46.

The telephone control circuit 46 comprises an ordinary microcomputer including a CPU, a RAM, a ROM, an I/O and the like. The telephone control circuit 46 is actuated by executing a program stored in the ROM. When actuated, it receives various signals from the interface circuit 43, the operation device 44, and the wireless communication unit 47, as required, outputs various signals to the interface circuit 43, the display device 45, and the wireless communication unit 47, reads data from the RAM and the ROM, and writes data to the RAM. The wireless communication unit 47 for performing well-known wireless telephone communication includes an antenna for wireless telephone communication, a transmission and reception circuit, a microphone for acquiring speaker's voice, a loudspeaker for outputting voice from a communication party, a ring tone and the like, a motor for vibrating the portable telephone 4, LED, a storage medium, and a telephone call control circuit for controlling these devices. On wirelessly receiving an incoming-call signal via an antenna for wireless telephone communication, the telephone call control circuit outputs a ring tone signal to the loudspeaker.

During communication, the telephone call control circuit outputs a voice signal from a communication party wirelessly received via the antenna for wireless telephone communication and the transmission and receiving circuit to the loudspeaker, and wirelessly transmits a voice signal received from the microphone for acquiring speaker's voice to the communication party via the antenna for wireless telephone communication and the transmission and receiving circuit. Based on a user's call operation on the operation device 44, the telephone call control circuit wirelessly transmits a signal for calling a call destination specified in the operation to the transmission and receiving circuit.

The wireless communication unit 47 has plural internal states. The internal states include normal mode, manner mode, silent mode and driving mode. The telephone call control circuit operates as described above in the normal mode; in manner mode, when a call arrives, drives the motor for vibrating the portable telephone 4 without outputting an incoming-call signal to the loudspeaker; and in silent mode, when a call arrives, blinks the LED without outputting an incoming-call signal to the loudspeaker.

The telephone call control circuit, when the wireless communication unit 47 is in the driving mode and a call arrives, without outputting an incoming-call signal to the loudspeaker, wirelessly transmits to a caller the voice data indicating that the call cannot be received because the vehicle is in the middle of driving, the voice data being stored in advance in the storage medium. When the wireless communication unit 47 is in the driving mode, even though a user performs a call operation on the operation device 44 of the portable telephone 4, the telephone call control circuit does not issue the call but instructs the display device 45 to display a message indicating that the call cannot be issued because operation is in progress. Such an operation to suppress incoming calls and outgoing calls to and from the portable telephone 4 in the driving mode is referred to as a driving mode function 48.

The wireless communication unit 47 transitions among the internal states by receiving a control signal for mode selection from the phone control circuit 46.

As shown in FIG. 6, the communication module 5 includes a transmitting circuit 51, a transmitting antenna 52, a receiving circuit 53, a receiving antenna 54, a rewritable nonvolatile storage medium EEPROM 55, an interface circuit 56 and a module control circuit 57.

The transmitting circuit 51 performs processing conforming to a given wireless communication protocol such as digital-to-analog conversion, modulation, frequency conversion, and amplification for data received from the module control circuit 57, and outputs a signal indicating the result to the transmitting antenna 52. The wireless communication protocol used here is one that enables the receiving unit 23 of the wheel physical state transmitter 2 and the receiving unit 33 of the smart entry vehicle unit 3 to receive data that can be correctly read.

The reception frequency bands of the receiving unit 23 and the receiving unit 33 are almost the same and slightly different from each other. Therefore, a circuit used for frequency conversion and modulation in the transmitting circuit 51 may be constructed to meet only one frequency band. However, two sets of circuits meeting two frequency bands may be provided to perform wireless transmission to the receiving unit 23 and the receiving unit 33, respectively. The transmitting circuit 51 performs adjustment of the output power of the wireless transmission and fine adjustment of transmission frequency under control of the module control circuit 57.

The receiving circuit 53 performs processing conforming to a given wireless communication protocol such as amplification, frequency conversion, demodulation, and analog-to-digital conversion for a signal received by the receiving antenna 54, and outputs a signal indicating the result to the module control circuit 57. The wireless communication protocol used here is one that enables correct reading of data in a radio signal transmitted by the transmitting unit 31 of the wheel physical state transmitters 2 and the transmitting unit 31 of the smart entry vehicle unit 3.

The transmission frequency bands of the receiving unit 23 and the receiving unit 33 are almost the same and slightly different from each other. Therefore, a circuit used for frequency conversion and demodulation in the receiving circuit 53 may be constructed to meet only one frequency band. However, two sets of circuits meeting two frequency bands may be provided to wirelessly receive signals from the transmitting unit 21 and the transmitting unit 31, respectively.

The interface circuit 56 is coupled with the interface circuit 43 of the portable telephone 4 in an inner portion of the mounting slot to achieve an electric and physical connection between the portable telephone 4 and the communication module 5. The connection is detachably made. When the interface circuit 56 is connected with the interface circuit 43 of the portable telephone 4, the interface circuit 56 supplies power received from the interface circuit 43 to the above parts of the communication module 5.

By this construction, the parts of the communication module 5 are activated. Also, when the interface circuit 56 is connected with the interface circuit 43 of the portable telephone 4, the interface circuit 56 outputs a signal outputted from the interface circuit 43 to the module control circuit 57, and outputs a signal received from the module control circuit 57 to the interface circuit 43.

The module control circuit 57 comprises an ordinary microcomputer including CPU, RAM, ROM, I/O, and the like. The module control circuit 57 is brought into operation by executing a program stored in the ROM. When actuated, it receives various signals from the receiving circuit 53 and the interface circuit 56, as required, outputs various signals to the transmitting circuit 51 and the interface circuit 56, reads data from the RAM, the ROM, and the EEPROM 55, and writes data to the RAM and the EEPROM 55.

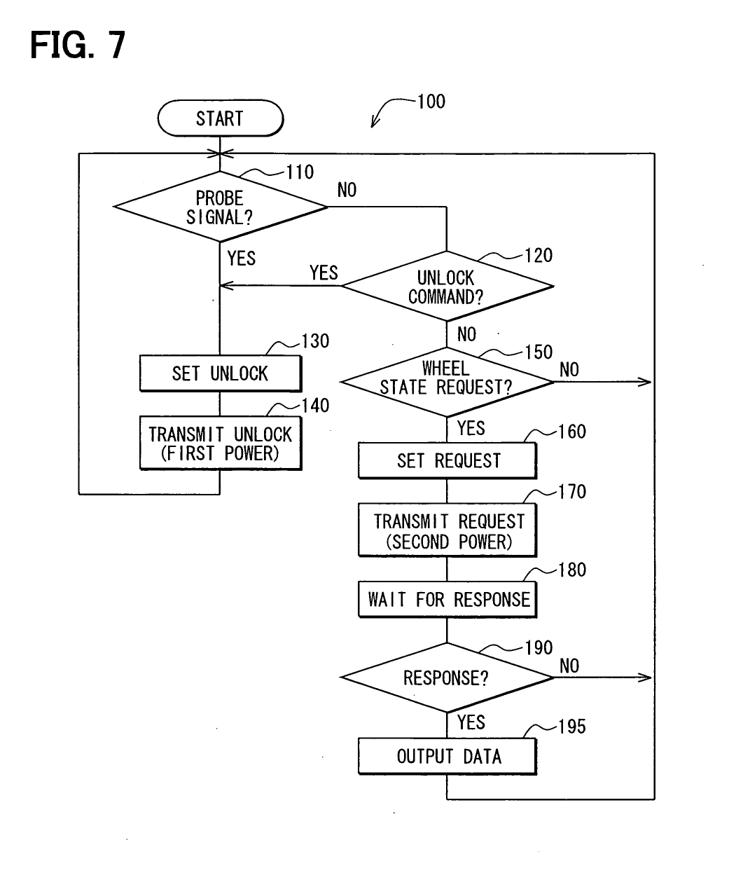

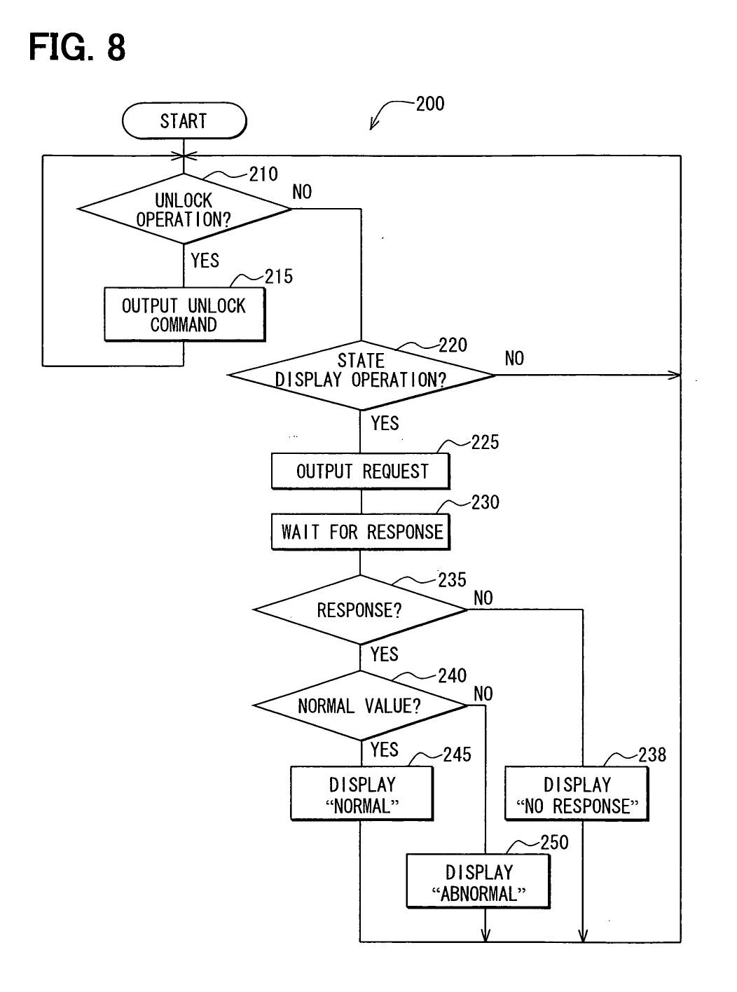

When the communication module 5 is mounted or inserted in the portable telephone 4, the module control circuit 57 operates by receiving power from the communication module 5 via the interface circuit 43, and executes a program 100 shown in FIG. 7. The telephone control circuit 46 executes a program 200 shown in FIG. 8 when detecting that the communication module 5 has been mounted in the interface circuit 43, or at the time of startup.

Processing of the programs 100 and 200 will be described below with respect to three cases:
(1) when a user performs an operation for displaying a physical state of a wheel on the operation device 44 of the portable telephone 4 in a range of tens of centimeters from any one of wheels of the vehicle 1;
(2) when the receiving circuit 53 of the communication module 5 receives a probe signal from the smart entry vehicle unit 3; and
(3) when a user performs an unlock operation on the operation device 44 of the portable telephone 4 in a range of several meters from the vehicle 1.

(1) In the case that a user performs an operation for displaying a physical state of a wheel on the operation device 44 of the portable telephone 4 in a range of tens of centimeters from any one of wheels of the vehicle 1, the telephone control circuit 46 determines in step (S) 210 of the program 200 that no unlock operation is performed, and based on the determination, determines in S220 that an operation for displaying a physical state of a wheel, that is, a wheel physical state display operation has been performed. Based on the determination, in S225, it outputs a prescribed wheel physical state request command to the interface circuit 43. As a result, the wheel physical state request command is passed to the module control circuit 57 via the interface circuit 43 and the interface circuit 56. Furthermore, in S230, the telephone control circuit 46 receives response data for the wheel physical state request command from the interface circuit 43, or waits until a prescribed first time (e.g., 20 seconds) elapses.

At this time, the module control circuit 57 determines in S110 that a probe signal is not received, and based on the determination, determines in S120 that an unlock command is not received. Based on the determination, it determines in S150 that the wheel physical state request command is received from the interface circuit 56.

Based on the determination, in S160, setting for transmitting a wheel physical state request signal is performed. In this setting, specifically, the transmitting circuit 51 is controlled so as to perform fine adjustment of a transmission frequency and adjustment of transmission output power to perform wireless transmission to the wheel physical state transmitter 2, of the wheel physical state transmitter 2 and the smart entry vehicle unit 3. The output power set here is defined as first output power. The first output power is necessary for the wheel physical state transmitter 2 about 50 centimeters away from the communication module 5 to correctly receive a signal transmitted with the output power.

In S170, the wheel physical state request signal is actually transmitted to the transmitting circuit 51. As a result, via the transmitting circuit 51 and the transmitting antenna 52, the wheel physical state request signal is wirelessly transmitted to each wheel physical state transmitters 2. On receiving the wheel physical state request signal from the receiving unit 23, the wheel physical state transmitter 2 mounted in a wheel nearest the portable telephone 4 and the communication module 5 wirelessly transmits the data of tire air pressure acquired from the pressure sensor 25 and tire temperature acquired from the temperature sensor 26 from the transmitting unit 21 as wheel physical state data.

In S180, the module control circuit 57 waits until it receives the wheel physical state data as a response from the wheel physical state transmitter 2, or until a prescribed second time (shorter than the first wait time, e.g., 10 seconds) elapses. On reception of a response or when the prescribed second wait time has elapsed, the module control circuit 57 determines in S190 whether a response has been returned in S180, that is, it has received the wheel physical state data as a response from the wheel physical state transmitter 2. On determining that no response is returned, the module control circuit 57 executes S110 again. When a response has been returned, in S195, it outputs the wheel physical state data received in the interface circuit 56, that is, response data. Thereby, via the interface circuit 56 and the interface circuit 43, the telephone control circuit 46 receives the response data. S195 is followed by S110 again to determine whether the probe signal is received.

When the telephone control circuit 46 having been waiting for response data in Step 230 of the program 200 receives the response data within the first prescribed wait time, it determines in S235 that response data has been returned, then determines in S240 whether wheel physical quantities included in the response data are normal values. Specifically, it may be determined whether a tire air pressure included in the response data is in a normal reference range, or it is above or below the normal reference range. Furthermore, it may be determined whether a tire temperature included in the response data is in a normal reference range, or it is above or below the normal reference range. Both a tire air pressure and a tire temperature may be checked.

If the wheel physical quantities are normal values as a result of the determination, in S245, the telephone control circuit 46 instructs the display device 45 to visually or by voice display a message indicating normality and the physical quantities of the wheel concerned (time air pressure and tire temperature). If the wheel physical quantities are not normal values as a result of the determination, in S250, the telephone control circuit 46 instructs the display device 45 to visually or by voice display a warning message indicating abnormality and the physical quantities of the wheel concerned (time air pressure and tire temperature). S S245 and S250 are followed by S210 again to determine whether an unlock operation is performed.

When the prescribed time has elapsed in S230 without response data being returned, the telephone control circuit 46 determines in S235 that no response is returned, then in S238 instructs the display device 45 to visually or by voice display a message indicating that no response is returned, and then executes S210.

By the above-mentioned operation of the telephone control circuit 46 and the module control circuit 57, when an operation for displaying physical states of wheels is performed on the operation device 44, the telephone control circuit 46 detects it and transmits a wheel physical state request command to the module control circuit 57 (SS220 and S230). On receiving the wheel physical state request command from the interface circuit 56, the module control circuit 57 instructs the transmitting circuit 51 to transmit a wheel physical state request signal with first output power (S160 and S170). As a result, on receiving response data from the wheel physical state transmitter 2, the module control circuit 57 outputs the response data to the telephone control circuit 46 via the interface circuit 56 (S195). The telephone control circuit 46 displays physical states based on the received response data in the display device 45 (S S240, S245, and S250).

When an operation for displaying the physical state of wheel is performed on the operation device 44, the module control circuit 57 instructs the transmitting circuit 51 to transmit a wheel physical state request signal with first output power. As a result, on receiving response data from the wheel physical state transmitter 2, the module control circuit 57 outputs a signal for displaying the response data on the display device of the portable telephone 4 via the interface circuit 56.

(2) In the case that the receiving circuit 53 of the communication module 5 receives a probe signal from the smart entry vehicle unit 3 and the doors are unlocked, the module control circuit 57 determines in S110 of the program 100 that it has received a prescribed probe signal from the smart entry vehicle unit 3 via the receiving circuit 53. When an identification code of the smart entry vehicle unit 3 included in the received probe signal matches prescribed identification code specific to the communication module 5 stored in advance in the EEPROM 55, the module control circuit 57 makes a positive determination (YES), that is, determines that it has received a prescribed probe signal.

Based on the determination, in S130, it performs the setting of transmitting an unlock signal. In this setting, the transmitting circuit 51 is controlled so as to perform fine adjustment of a transmission frequency and adjustment of transmission output power to perform wireless transmission to the smart entry wheel unit 3, of the wheel physical state transmitter 2 and the smart entry vehicle unit 3. The output power set here is defined as second output power, which is higher than first output power. The second output power is such that the smart entry vehicle unit 3 about several meters away from the communication module 5 can correctly receive a signal transmitted with the output power.

In S140, an unlock signal is actually transmitted to the transmitting circuit 51. The unlock signal includes the same verification code as prescribed code stored in the smart entry vehicle unit 3. The verification code is stored in advance in the EEPROM 55. S140 is followed by S110 again to determine whether a probe signal is received.

Thus, based on the reception of a prescribed probe signal (S110), the module control circuit 57 adjusts the output power of wireless transmission of the transmitting circuit 51 to the second output power and finely adjusts a transmission frequency to a frequency for the smart entry vehicle unit 3 (S130). Then, the module control circuit 57 instructs the transmitting circuit 51 to transmit an unlock signal including prescribed verification code (S140).

(3) In the case that a user performs an unlock operation on the operation device 44 of the portable telephone 4 in a range of several meters from the vehicle 1, the telephone control circuit 46 determines in S210 of the program 200 that an unlock operation has been performed on the operation device 44. It then outputs in S215 a prescribed unlock command to the interface circuit 43. Thereby, the unlock command is passed to the module control circuit 57 via the interface circuit 43 and the interface circuit 56. S215 is followed by S210 to perform determination processing.

The module control circuit 57 determines in S110 that it does not receive a probe signal, then determines in S120 that it has received an unlock command from the interface circuit 56. Then, in S130 and S140, the same processing as described in (2) is performed.

By the above operation of the telephone control circuit 46 and the module control circuit 57, when an operation for transmitting an unlock signal has been performed on the operation device 44 of the portable telephone 4, the telephone control circuit 46 detects it and transmits an unlock command to the module control circuit 57 (S210 and S215). On receiving the unlock command from the interface circuit 56, the module control circuit 57 instructs the transmitting circuit 51 to transmit an unlock signal for the smart entry vehicle unit 3 with the second output power (S130 and S140).

When an unlock operation has been performed on the operation device 44, the module control circuit 57 instructs the transmitting circuit 51 to transmit an unlock signal for the smart entry vehicle unit 3 with the second output power.

When the module control circuit 57, in execution of the program 100, determines in S110 that it does not receive a probe signal, determines in S120 that it does not receive an unlock command, and determines in S150 that it does not receive a wheel physical state request command, it repeatedly executes S110, S120 and S150 in that order. In this case, time required for one cycle of the repetition should be a time period (e.g., 10 or 100 milliseconds) sufficiently shorter than a transmission interval (e.g., one second) of the probe signal in the smart entry vehicle unit 3.

By virtue of the above operation, by mounting the communication module 5 in a user-carriable equipment (e.g., the portable telephone 4), the following functions are achieved; a function that, when a user performs a wheel physical state request operation, a wheel physical state request signal is transmitted to the wheel physical state transmitter 2, and as a result, receives and displays in a display device wheel physical state data from the wheel physical state transmitters 2; a function (that is, so-called smart entry function) that, on receiving a probe signal from the smart entry vehicle unit 3, transmits an unlock signal for automatically unlocking doors of the vehicle; and a function (that is, so-called keyless entry function) that, when a user performs an unlock operation, transmits an unlock signal for unlocking doors of the vehicle.

The first output power with which the transmitting circuit 51 transmits a wheel physical state request signal is lower than the second output power with which the transmitting circuit 51 transmits an unlock signal. More specifically, the first output power is such that the reach range of the wheel physical state request signal is shorter than the distance between wheels that is, e.g., about 50 centimeters. The second output power is such that the unlock signal reaches a wider range than the length of the vehicle, which is, e.g., about several meters. By this construction, if the wheel physical state request signal is transmitted near a desired wheel, since it hardly reaches other wheels, it will not occur that wheel physical state signals are transmitted from plural wheels and interfere with one another. The unlock signal reaches the smart entry vehicle unit 3 even from a place about several meters away from the vehicle.

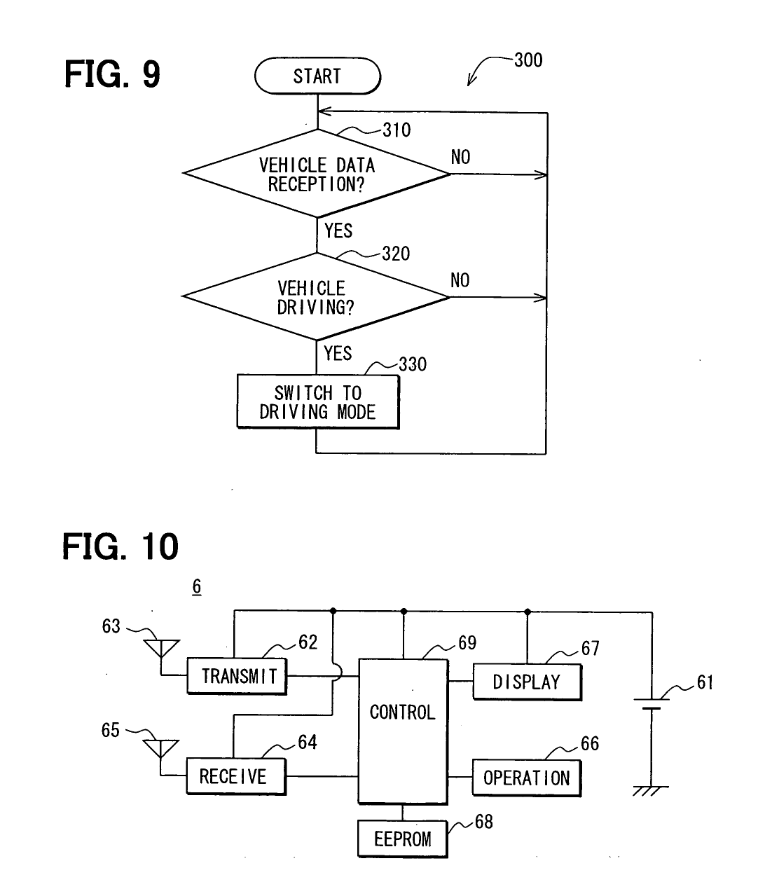

The module control circuit 57, when the communication module 5 is mounted in the portable telephone 4, executes a program 300 shown in FIG. 9. In execution of the program, the module control circuit 57 determines in S310 whether it has wirelessly received vehicle data via the receiving circuit 53. The vehicle data, which is data in the probe signal wirelessly received by the smart entry vehicle unit 3, includes data concerning the vehicle such as vehicle speed and vehicle ignition state, in addition to the identification code of the smart entry vehicle unit 3. Vehicle speed data and vehicle ignition state data respectively indicate whether the vehicle is in the middle of driving and running, and whether the vehicle is in the middle of driving.

When identification code of the smart entry vehicle unit 3 included in the received vehicle signal matches prescribed identification code stored in advance in the EEPROM 55, the module control circuit 57 makes a positive determination, that is, determines that it has received prescribed vehicle data. If it has received vehicle data, it proceeds to S320, and otherwise executes again S310.

In S320, the module control circuit 57 determines whether the vehicle is in the middle of driving from whether ignition state data in the received vehicle data indicates ON. If the ignition state data is not included in the vehicle data, whether the vehicle is in the middle of driving may be determined from whether vehicle speed data in the vehicle data substantially indicates the middle of driving (e.g., speed per hour 1 km or faster). When the vehicle speed data is used, substantially it is determined that the vehicle is in the middle of driving and running. On determining that the vehicle is in the middle of driving, the module control circuit 57 executes S330, and on determining that the vehicle is not in the middle of driving, it executes S310.

In S330, the module control circuit 57 performs control for switching the portable telephone 4 to the driving mode. Specifically, it outputs a driving mode shift command to the interface circuit 56. Thereby, the driving mode shift command is passed to the telephone control circuit 46 via the interface circuit 56 and the interface circuit 43. On receiving the driving mode shift command, the telephone control circuit 46 outputs a control signal for mode switching to the wireless communication unit 47 to request a shift to the driving mode. As a result, the wireless communication unit 47 enters the driving mode in which incoming calls and outgoing calls to and from the portable telephone 4 are suppressed. S330 is followed by S310 again.

By the execution of the program. 300, based on the wireless receiving of the vehicle data indicating that the vehicle is in the middle of driving, from the smart entry vehicle unit 3 (S310 and S330), the incoming-call and outgoing-call operations of the wireless communication unit 47 are suppressed. By this construction, the wireless telephone communication function of the portable telephone 4 is suppressed when the vehicle is in the middle of driving.

The on-vehicle radio transmitter referred to here may be a door unlock device that transmits the above probe signal, and may be other devices.

The wireless telephone communication function of the portable telephone 4 is not suppressed unless identification code stored in the EEPROM 55 matches identification code from the smart entry vehicle unit 3. Therefore, even when a portable telephone 4 owned by other than a user of a vehicle provided with the smart entry vehicle unit 3 is in the vehicle and the vehicle is in the middle of driving, the wireless communication function of the portable telephone 4 is not suppressed.

Such vehicle data does not always need to be transmitted from the smart entry vehicle unit 3, and may be transmitted as a radio signal from other on-vehicle wireless transmitters of the vehicle.

### Second Embodiment

In a second embodiment, as shown in FIG. 10, a portable communication device 6 is provided for communication with the wheel physical state transmitter 2 and the smart entry vehicle unit 3. The portable communication device 6 is a user-carriable integrated communication device that includes a battery 61, a transmitting circuit 62, a transmitting antenna 63, a receiving circuit 64, a receiving antenna 65, an operation device 66, a display device 67, an EEPROM 68 and a control circuit 69.

The battery 61 supplies power to the above components of the portable communication device 6 to actuate them.

The transmitting circuit 62 performs processing conforming to a given wireless communication protocol such as digital-to-analog conversion, modulation, frequency conversion and amplification for data received from the control circuit 69, and outputs a signal indicating the result to the transmitting antenna 63. The wireless communication protocol used here is one that enables the receiving unit 23 of the wheel physical state transmitter 2 and the receiving unit 33 of the smart entry vehicle unit 3 to receive data that can be correctly read. The reception frequency bands of the receiving unit 23 and the receiving unit 33 are almost the same and slightly different from each other.

Therefore, a circuit used for frequency conversion and modulation in the transmitting circuit 62 may be constructed to meet only one frequency band.

However, two sets of circuits meeting two frequency bands may be provided to perform wireless transmission to the receiving unit 23 and the receiving unit 33, respectively. The transmitting circuit 62 can perform adjustment of the output power of the wireless transmission and fine adjustment of transmission frequency under control of the control circuit 69.

The receiving circuit 64 performs processing conforming to a given wireless communication protocol such as amplification, frequency conversion, demodulation, and analog-to-digital conversion for a signal received by the receiving antenna 65, and outputs a signal indicating the result to the module control circuit 69. The wireless communication protocol used here is one that enables correct reading of data in a radio signal transmitted by the transmitting unit 31 of the wheel physical state transmitter 2 and the transmitting unit 31 of the smart entry vehicle unit 3. Also, the transmission frequency bands of the receiving unit 23 and the receiving unit 33 are almost the same and slightly different from each other. Therefore, a circuit used for frequency conversion and demodulation in the receiving circuit 64 may be constructed to meet only one frequency band. However, two sets of circuits meeting two frequency bands may be provided to wirelessly receive signals from the transmitting unit 21 and the transmitting unit 31, respectively.

The operation device 66 accepts a user operation by buttons, switches, and the like, and outputs a signal corresponding to the accepted operation to the telephone control circuit 69.

The display device 67 includes an image display device such as a liquid crystal display that outputs a video based on a video signal received from the control circuit 69, and a loudspeaker that outputs a sound based on a tone signal received from the control circuit 69.

The control circuit 69 comprises an ordinary microcomputer including a CPU, a RAM, a ROM, an I/O and the like. The control circuit 69 is actuated by executing a program stored in the ROM. When actuated, it receives various signals from the receiving circuit 64 and the operation device 65, as required, outputs various signals to the transmitting circuit 62 and the display device 67, reads data from the RAM, the ROM and the EEPROM 68, and writes data to the RAM and the EEPROM 68.

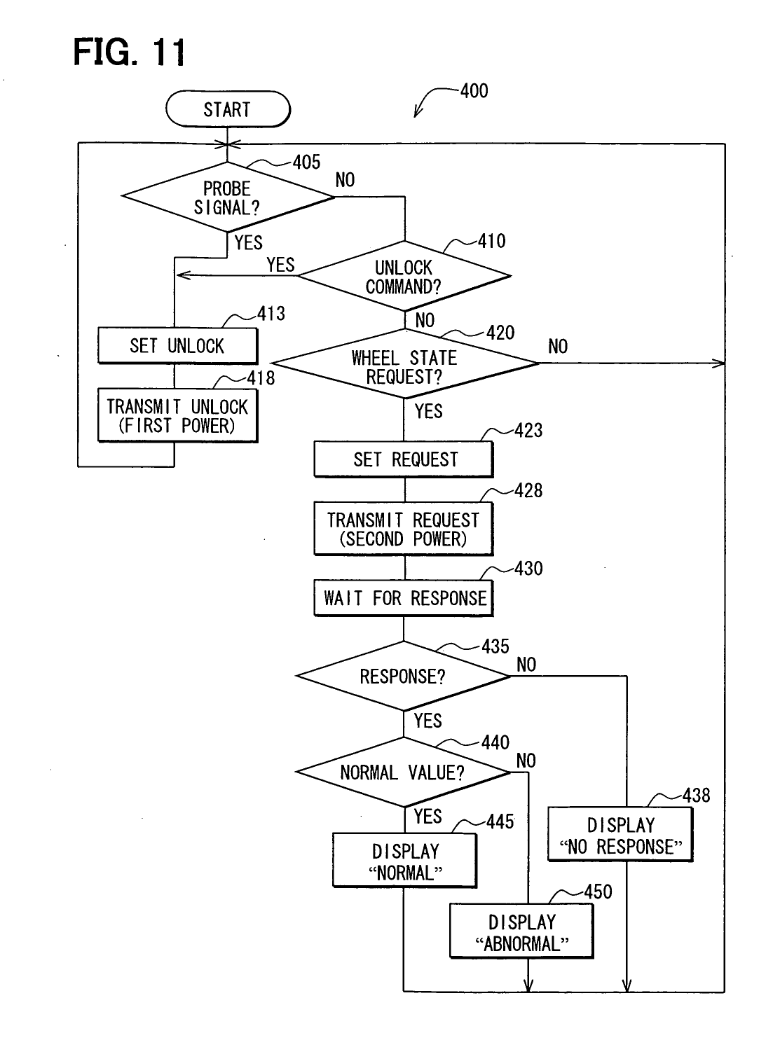

FIG. 11 shows processing of a program 400 executed by the control circuit 69 with respect to the following three cases:
(1) when a user performs an operation for displaying a physical state of a wheel on the operation device 66 of the portable telephone 4 in a range of tens of centimeters from any one of wheels of the vehicle 1;
(2) when the receiving circuit 64 receives a probe signal from the smart entry vehicle unit 3; and
(3) when a user performs an unlock operation on the operation device 66 in a range of several meters from the vehicle 1.

(1) When a user performs an operation for displaying a physical state of a wheel on the operation device 66 in a range of tens of centimeters from any one of wheels of the vehicle 1, the control circuit 69 determines in S405 that the receiving circuit 64 does not receive a probe signal. Based on this determination, the control circuit 69 determines in S410 that an unlock operation is not performed on the operation device 66. Based on this determination, the control circuit 69 determines in Step 420 that an operation for displaying a physical state of a wheel, that is, a wheel physical state display operation has been performed. Based on the determination, in S423, like S160 of the program 100 shown in FIG. 7, setting for transmitting a wheel physical state request signal is performed. That is, transmission output power of the transmitting circuit 62 is set to the first output power, and a transmission frequency for the wheel physical state transmitter 2 is set.

In S428, the wheel physical state request signal is actually transmitted to the transmitting circuit 62. As a result, via the transmitting circuit 62 and the transmitting antenna 63, the wheel physical state request signal is wirelessly transmitted to the wheel physical state transmitters 2. According to the wheel physical state request signal, the wheel physical state transmitter 2 mounted to a wheel nearest the portable communication device 6 wirelessly transmits wheel physical state data like that in the first embodiment.

In S430, like S180 of the program 100, the control circuit 69 waits until it receives the wheel physical state data as a response from the wheel physical state transmitter 2, or until a prescribed time (e.g., 20 seconds) elapses. On reception of a response or when the prescribed wait time has elapsed, the control circuit 69 determines in S435 whether a response has been returned in S430, that is, it has received the wheel physical state data as a response from the wheel physical state transmitter 2.

When a response has been returned, in S440, like S240 of the program 100, the control circuit 69 determines whether wheel physical quantities included in the response data are normal values.

If the wheel physical quantities are normal values as a result of the determination, in S445, the control circuit 69 instructs the display device 67 to visually or by voice display a message indicating normality and the physical quantities of the wheel concerned (time air pressure and tire temperature). If the wheel physical quantities are not normal values as a result of the determination, in S450, the control circuit 69 instructs the display device 67 to visually or by voice display a warning message indicating abnormality and the physical quantities of the wheel concerned (time air pressure and tire temperature). S445 and S450 are followed by S405 again to determine whether the probe signal is received.

When the prescribed time has elapsed in S430 without response data being returned, the control circuit 69 determines in S435 that no response is returned. Then in S438 the control circuit 69 instructs the display device 67 to visually or by voice display a message indicating that no response is returned, and then executes Step 405.

By the above operation of the control circuit 69, when an operation for displaying physical states of wheels is performed on the operation device 66, the transmitting circuit 62 transmits the wheel physical state request signal with the first output power (S423 and S428). As a result, on receiving the response data from the wheel physical state transmitter 2, the control circuit 69 displays physical state based on the response data in the display device 67 (S440, S445 and S450).

(2) When the receiving circuit 64 receives a probe signal from the smart entry vehicle unit 3, the control circuit 69 determines in S405 that it has received a prescribed probe signal from the smart entry vehicle unit 3 via the receiving circuit 64. When identification code of the smart entry vehicle unit 3 included in the received probe signal matches prescribed identification code specific to the portable communication device 6 stored in advance in the EEPROM 68, the control circuit 69 makes a positive determination, that is, determines that it has received a prescribed probe signal.

Based on the determination, in S413, it performs the setting of transmitting an unlock signal like Step 130 of the program 100.

In S418, an unlock signal is actually transmitted to the transmitting circuit 62. The unlock signal includes the same verification code as prescribed code stored in the smart entry vehicle unit 3. The verification code is stored in advance in the EEPROM 68. S418 is followed by S405 again to determine whether a probe signal is received.

Thus, based on the reception of a prescribed probe signal (S405), the control circuit 69 adjusts the output power of wireless transmission of the transmitting circuit 62 to the second output power and finely adjusts a transmission frequency to a frequency for the smart entry vehicle unit 3 (S413). Then, the control circuit 69 instructs the transmitting circuit 62 to transmit an unlock signal including prescribed verification code (S418).

(3) When a user performs an unlock operation on the operation device 66 in a range of several meters from the vehicle 1, the control circuit 69 determines in S405 of the program 400 that a probe signal is not received. The control circuit 69 then determines in S410 that an unlock operation has been performed on the operation device 66, and then in S413 and S418 performs the same processing as described in the above case (2).

By the above operation of the control circuit 69, when an operation for transmitting an unlock signal has been performed on the operation device 66, the control circuit 69 instructs the transmitting circuit 62 to transmit an unlock signal for the smart entry vehicle unit 3 with the second output power (S413 and S418).

When the control circuit 69, in execution of the program 400, determines in S405 that it does not receive a probe signal, determines in S410 that it does not receive an unlock command, and determines in S420 that it does not receive a wheel physical state request command, it repeatedly executes S405, S410 and S420 in that order. In this case, time required for one cycle of the repetition should be a time period (e.g., 10 or 100 milliseconds) sufficiently shorter than a transmission interval (e.g., one second) of the probe signal in the smart entry vehicle unit 3.

By virtue of the above operation, a user-carried equipment (e.g., the portable communication device 6) can achieve the following functions. That is, when a user performs a wheel physical state request operation, a wheel physical state request signal is transmitted to the wheel physical state transmitters 2, and then wheel physical state data is received from the wheel physical state transmitter 2 and displayed in a display device. When a probe signal is received from the smart entry vehicle unit 3, a lock/unlock signal is transmitted for automatically locking or unlocking doors of the vehicle. When a user performs a lock/unlock operation, a lock/unlock signal is transmitted for locking or unlocking doors of the vehicle.

The first output power with which the transmitting circuit 62 transmits a wheel physical state request signal is lower than the second output power with which the transmitting circuit 51 transmits a lock/unlock signal. More specifically, the first output power is such that the reach range of the wheel physical state request signal is shorter than the distance between wheels that is, e.g., about 50 centimeters. The second output power is such that the lock/unlock signal reaches a wider range than the length of the vehicle, which is, e.g., about several meters. By this construction, if the wheel physical state request signal is transmitted near a desired wheel, since it hardly reaches other wheels, it seldom arises that wheel physical state signals are transmitted from plural wheels and interfere with one another. The unlock signal reaches the smart entry vehicle unit 3 even from a place about several meters away from the vehicle.

In the above embodiments, the smart entry vehicle unit 3 corresponds to a door unlock device and an on-vehicle wireless transmitter.

In the first embodiment, a combination of the portable telephone 4 and the communication module 5 corresponds to a portable communication device. The portable telephone 4 corresponds to portable electronic equipment. The communication module 5 corresponds to a communication device designed to be mounted in the portable electronic equipment.

A combination of the telephone control circuit 46 and the module control circuit 57 corresponds to a control circuit. The telephone control circuit 46 corresponds to a mounting side control circuit. The wireless communication unit 47 corresponds to wireless telephone communication means. The module control circuit 57 thus performs telephone suppression function by executing the program 300.

By S130 and S140 of the program 100 executed by the module control circuit 57, lock/unlock signal transmission is achieved. By S240, S245 and S250 of the program 200 executed by the telephone control circuit 46, the display control is achieved. By S220 of the program 200 executed by the telephone control circuit 46, the function of wheel physical state display operation detection is achieved. By S160 and S170 of the program 100 executed by the module control circuit 57, the wheel physical state display operation detection is achieved. By S195 of the program 100 executed by the module control circuit 57, the wheel physical state display output is achieved.

In the second embodiment, by S413 and S418 of the program 400 executed by the control circuit 69, the unlock signal transmission control is achieved. By S440, S445 and S450 of the program 400 of the control circuit 69, the display control is achieved. By S420 of the program 400 executed by the control circuit 69, the wheel physical state display operation detection is achieved. By S423 and S428 of the program 400 executed by the control circuit 69, the wheel physical state request signal transmission control is achieved.

### Other Embodiments

Although, in the first embodiment, the portable telephone 4 is shown as an example of a portable electronic equipment, it does not necessarily need to be a cellular phone but may be any portable electronic equipment that can detachably mount the communication module 5, such as, for example, PDA, a digital camera, and a video camera.

A portable electronic equipment includes a memory card slot as a card slot, and a communication device designed to be mounted in the portable electronic equipment has such an appearance and an interface circuit that it is inserted in the memory card slot. The communication device designed to be mounted in the portable electronic equipment may be detachably mounted in the portable electronic equipment by being inserted in the memory card slot. A slot portion through which the communication device designed to be mounted in the portable electronic equipment is detachably mounted in the portable electronic equipment may not comply with standards widely used such as memory card but may has a specific structure. In this case, the communication device designed to be mounted in the portable electronic equipment must have such an appearance and an interface circuit that it is detachably mounted in the specific slot.

In the first embodiment, the module control circuit 57 determines whether the vehicle is in the middle of driving, by executing the program 300. However, whether the vehicle is in the middle of driving or running may be determined by the telephone control circuit 46. In this case, when the module control circuit 57 receives a probe signal including vehicle data via the receiving circuit 53, it outputs it to the interface circuit 56. The telephone control circuit 46 receives the vehicle data via the interface circuit 56 and the interface circuit 43, and executes determination of S320 based on the received vehicle data. On determining that the vehicle is in the middle of driving or running, the telephone control circuit 46 outputs a control signal to request to switching to a driving mode to the wireless communication unit 47.

In the first and the second embodiments, a combination of the portable telephone 4 and the communication module 5, and the portable communication device 6 achieve the keyless entry function and the smart entry function, respectively. However, for example, only the keyless entry function of them may be achieved.

1-5. (canceled)

6. A communication device detachably mounted in portable electronic equipment, comprising:
an interface circuit for detachably connecting to the portable electronic equipment;
a transmitting circuit that wirelessly transmits a signal to a door locking device that locks or unlocks doors of a vehicle when wirelessly receiving a lock/unlock signal from outside the vehicle, the transmitting circuit operating under power supplied from the portable electronic equipment connected via the interface circuit; and
a mounting side control circuit that operates under power supplied from the portable electronic equipment connected via the interface circuit,
wherein the mounting side control circuit functions as a lock/unlock signal transmission control means that instructs the transmitting circuit to transmit the lock/unlock signal to the door locking device.

7. The communication device according to claim 6, wherein
the lock/unlock signal transmission control means instructs the transmitting circuit to transmit the lock/unlock signal to the door locking device when receiving via the interface circuit a signal outputted from the portable electronic equipment when a user performs a locking/unlocking operation on an operation device of the portable electronic equipment.

8. The communication device according to claim 6, further comprising:
a receiving circuit that wirelessly receives a signal wirelessly transmitted from a wheel physical state transmitter that is mounted in a wheel and wirelessly transmits a signal indicating a physical state of the wheel,
wherein the mounting side control circuit further functions as a wheel physical state display output means that, when the receiving circuit receives a signal indicating a physical state of a wheel wirelessly transmitted from the wheel physical state transmitter, outputs a signal for displaying a physical state of a wheel relating to the signal in the display device via the interface circuit, the display device being included in the portable electronic equipment connected via the interface circuit.

9. The communication device according to claim 6, wherein
the transmitting circuit also wirelessly transmits to the wheel physical state transmitter a request signal indicating a request to transmit a physical state of a wheel,
the control circuit further functions as a wheel physical state request signal transmission control means that instructs the transmitting circuit to transmit a signal indicating a request to transmit a physical state of a wheel with first output power when receiving via the interface circuit a signal outputted from the portable electronic equipment when a user performs an operation for displaying a physical state of a wheel on an operation device of the portable electronic equipment, and
the lock/unlock signal transmission control means instructs the transmitting circuit to transmit the lock/unlock signal with second output power higher than the first output power.

10. The communication device according to claim 6, wherein
the receiving circuit wirelessly receives a signal from an on-vehicle wireless transmitter, and
the mounting side control circuit further outputs, when the receiving circuit wirelessly receives a signal from the on-vehicle wireless transmitter, a signal for suppressing an incoming-call or outgoing-call operation in a portable telephone connected via the interface circuit to the portable telephone via the interface circuit.

11. The portable communication device according to claim 6, wherein
the receiving circuit wirelessly receives also a signal wirelessly transmitted from the door locking device that wirelessly transmits a prescribed probe signal, and locks or unlocks vehicle doors when wirelessly receiving a lock/unlock signal, and
the lock/unlock signal transmission control means instructs the transmitting circuit to transmit the lock/unlock signal when the receiving circuit receives the prescribed probe signal.
